(19) United States
(12) Patent Application Publication
(10) Pub. No.: US 2025/0349160 A1
(43) Pub. Date: Nov. 13, 2025

(54) TRAILER HAVING A MANOEUVRING GUIDANCE SYSTEM

(71) Applicant: BOOSTPHYSICS B.V., Tilburg (NL)

(72) Inventor: Max De Feber, Tilburg (NL)

(73) Assignee: BOOSTPHYSICS B.V., Tilburg (NL)

(21) Appl. No.: 18/867,501

(22) PCT Filed: May 22, 2023
(86) PCT No.: PCT/IB2023/055240

§ 371 Date: Nov. 20, 2024

(30) Foreign Application Priority Data
May 20, 2022 (NL) 2031955

(51) Int. Cl. G07C 5/08; G01S 13/931; G07C 5/00

(52) U.S. Cl. CPC G07C 5/0816; G01S 13/931; G07C 5/008; G07C 5/085; G01S 2013/932; G01S 2013/9323; G01S 2013/9324; G01S 2013/93275

(57) ABSTRACT

Trailer (7) having a manoeuvring guidance system (1) and a method for guarding a condition of a manoeuvring assistant sensor (2) of the manoeuvring guidance system (1). The manoeuvring guidance system of the trailer comprises the manoeuvring assistant sensor (2), a control unit (3) and at least one surveillance sensor (4). The surveillance sensor (4) senses a change in a state of the manoeuvring assistant sensor (2) and delivers a corresponding output signal to communication means that are connected to said surveillance sensor (4). The communication means communicate a warning signal that is representative of said output signal to alerting means (8) in case a change in said state is observed by said surveillance sensor (4).

The current invention relates to a trailer comprising a front end portion with coupling means for coupling a towing vehicle, particularly a truck, a rear end portion, and a manoeuvring guidance system, comprising a control unit and at least one manoeuvring assistant sensor mounted to said rear end portion of said trailer. The invention further relates to a method for guarding a condition of at least one manoeuvring assistant sensor of a manoeuvring guidance system comprising at least one manoeuvring assistant sensor mounted to an exposed rear portion of a trailer.

Many towing vehicles are equipped with a manoeuvring guidance system that comprises one or more manoeuvring assistant sensors to assist a driver of the towing vehicle to manoeuvre the vehicle whilst driving. In this example, the vehicle is a towing vehicle of a trailer, like a truck trailer, a small trailer, a caravan or the like. The manoeuvring assistant sensors are normally located at extreme parts of the trailer in vulnerable, exposed positions on the trailer. The manoeuvring guidance system is typically active when driving in reverse or while rounding a corner.

A heavy-duty commercial transport environment is harsh to equipment, for example, people climbing on and off the vehicle and third party heavy equipment, for example, forklifts hitting the vehicle during loading or off-loading. This is one of the major reasons why manoeuvring assistant sensors seem to be damaged much more frequently when mounted on heavy-duty commercial vehicles, such as truck-trailers, than on passenger cars, where the sensors are integrated better in the vehicle design and the environment is more forgiving for such equipment. Additionally, on average heavy-duty commercial vehicles are used more frequently and drive more kilometres than passenger cars. This results in a lot of manoeuvring each day. In some cases, manoeuvring 30 times each day with each vehicle is typical. This yields a higher risk of damage to the manoeuvring assistant sensors, simply because of frequent daily usage.

A further problem is that trucks and trailers are in fact two separate vehicles, built by different manufacturers and each having their own license plates. In some cases a fleet might consist of tens of trucks (towing vehicles) and more than hundred trailers. It is common practise that truck and trailer combinations are mixed on a daily basis and typically one truck tows many different trailers each week. Therefore, the driver towing the trailer can be a different person each day or even during the same day. Because of this, it is not unlikely that no one may take responsibility for damage caused to a manoeuvring assistant sensor or damage caused to a trailer exterior if it occurs. This results in damage caused to the manoeuvring assistant sensor or the vehicle to remain unreported, which in turn results in the manoeuvring assistant sensor to not be repaired or aligned properly again. Due to the amount of different drivers per day, one cannot easily determine who was responsible for the trailer at the time of the incident and, moreover, a next driver may be totally ignorant of a damage to a sensor caused during a previous trip that may jeopardize the reliability of the system. A damaged manoeuvring assistant sensor may transmit false alarms or even no alarm at all to the user of the trailer. The user consequently starts to lose faith in the manoeuvring guidance system as a whole.

The present invention has for its object, among others, to provide a trailer with a manoeuvring guidance system that monitors a state of each manoeuvring assistant sensor, like its orientation and integrity. In a further aspect of the invention it is the object, among others, to provide a method that reports on the state of the manoeuvring assistant sensor(s) of a manoeuvring guidance system on a trailer.

In order to achieve the stated object a trailer with a manoeuvring guidance system of the type described in the preamble, according to the invention, is characterized in that each of said at least one manoeuvring assistant sensor is operationally coupled to at least one surveillance sensor that senses a change in a physical state of the manoeuvring assistant sensor associated therewith to deliver a corresponding output signal to said control unit over communication means that mutually connect said surveillance sensor and said control unit, and in that said control unit issues a warning signal to alerting means in case a deviation of said physical state is observed that exceeds a threshold.

The manoeuvring guidance system is installed on a trailer of which the surroundings need to be observed for obstructions. Said trailer may be any trailer being towed by a towing vehicle, like a trailer of a truck, a caravan or a car trailer. A user, being the driver of said vehicle or a third party, has access to the alerting means. The driver of the vehicle may be a person or artificial intelligence used in self-driving vehicles. The alerting means may be a light, an alarm, a display unit, a communication device for receiving an email, or a machine-to-machine message in case of artificial intelligence used in self-driving vehicles or the like. The alerting means may be located in a cabin of said towing vehicle or at any other location accessible to a user in the case where the vehicle is self-driven.

Should any change in the state of the manoeuvring assistant sensor occur, particularly an unexpected one, then the alerting means may receive the warning signal, notifying the user of said change in the state. Such change may, for example, be a change in the orientation of the manoeuvring assistant sensor as a result of an impact received or experienced by the manoeuvring assistant sensor. The change in the orientation of the manoeuvring assistant sensor may change the detection zone of said manoeuvring assistant sensor to, for example, detecting part of the ground. Once the user receives the notification of the change in state of the manoeuvring assistant sensor, the manoeuvring assistant sensor can be adjusted to a predetermined state, should needs be, particularly its initial state. In the case where the user is a third party, the user may also be able to determine who the driver of the vehicle was when the incident occurred based on the time of the incident and, accordingly, which party is responsible for the incident.

According to the invention a dedicated surveillance sensor monitors the state, particularly the orientation and/or the integrity, of the associated manoeuvring assistant sensor. To that end, the surveillance sensor is operationally coupled to the manoeuvring assistant sensor, for instance by being mechanically connected to it and/or accommodated is a common housing. At installation of the manoeuvring guidance system, an initial state of the one or more surveillance sensors, associated with the respective manoeuvring assistant sensor(s), is recorded to provide a reference value for the surveillance sensor(s). The recorded state is indicative of a corresponding state of an associated manoeuvring assistant sensor. Any software (sensitivity) settings of the manoeuvring assistant sensors may also be saved. This data is stored and defines the state of the manoeuvring guidance system at installation.

During operation of the surveillance sensor, the state of the surveillance sensor is periodically monitored at predetermined checkpoints. These checkpoints occur when specific conditions are met, for example, when the vehicle is stationary. To detect a change in state of the surveillance sensor, the surveillance sensor compares the values measured αₙ(tᵢ) against these reference values a (to), the value n indicating the number of the respective sensor. The following equation is used to determine the value of the change in state: |αₙ(tᵢ)−αₙ(t₀)|>Δmₙ, in which Δmₙ represents a threshold value for that sensor (n). The value of the change in state of the surveillance sensor is taken to be indicative of the value of the change in state of the associated manoeuvring assistant sensor as the sensors are operationally coupled, particularly moving together or confined in a same housing. The surveillance sensor communicates said change in state to the connected control unit. The control unit interprets the output signal and launches a warning signal if the threshold value Δmₙ seems to be exceeded. The surveillance sensor may particularly also be used to calibrate the state of manoeuvring assistant sensor at installation thereof. To that end, the surveillance sensor measures a pitch and yaw angle.

Additionally, the surveillance sensor angle measurements can be used to detect a distance between the surveillance sensor and the ground. This position of the surveillance sensor can be found by combining a pitch angle of the surveillance sensor with the manoeuvring assistant sensor detection angle and a closest ground echo distance. As the pitch, yaw and position of the surveillance sensor mainly determine the threshold curve, these measured or calculated values can be used to find the optimal threshold curve (i.e. sensitivity setting) for each manoeuvring assistant sensor at installation. This may be done by an algorithm that looks for the closest match on pitch, yaw and position in a digital table and then selects the corresponding threshold curve. This threshold-curve-table may be pre-programmed in the device or it could be available through an online database with which the device connects. These measurements can be used to advise a user, who installs the manoeuvring assistant sensor onto the trailer, whether the manoeuvring assistant sensor's mechanical angle or mechanical position should be altered, by mechanically adjusting the mounting of the sensor, or not. This could be required if the measured angles and position are out of a predetermined range or if no appropriate threshold curve can be found in the database for the measured angles and position.

A preferred embodiment of the trailer according to the invention is characterized in that said manoeuvring assistant sensor and surveillance sensor are located within a common casing, and particularly said common casing being a closed casing. The closed casing prevents any unwanted elements, for example, light or dust, from compromising the integrity of the manoeuvring assistant sensor. In a particular embodiment the surveillance sensor may be a light intensity sensor or a pressure sensor that is located within the same closed casing as the manoeuvring assistant sensor and within close proximity of the manoeuvring assistant sensor. The light sensor or pressure sensor may detect an increase in light intensity or change in atmospheric pressure when the enclosure becomes compromised, indicative of damage to the manoeuvring assistant sensor.

A further preferred embodiment of the trailer according to the invention is characterized in that said surveillance sensor is an accelerometer, a magnetometer or a gyroscope that moves in conjunction with the manoeuvring assistant sensor. The accelerometer, gyroscope or magnetometer may detect a change in its own orientation or acceleration of itself. The change in the orientation of the surveillance sensor or the acceleration of the surveillance sensor is indicative of a change in the state of the attached manoeuvring assistant sensor. Whenever a predetermined acceleration or orientation threshold is exceeded, the corresponding acceleration force magnitude and a timestamp can be stored in an electronic memory of the surveillance sensor and/or of the control unit.

The surveillance sensor, being the accelerometer, gyroscope and/or magnetometer, measures a pitch angle, a roll angle and/or a yaw angle of itself to determine the orientation and acceleration of the surveillance sensor. The pitch angle of the surveillance sensor can be measured by looking at the direction of a gravity vector. This may be done when the vehicle is stationary to eliminate accelerations on the surveillance sensor other than gravity. Gravitational force is constantly pointing towards Earth. The fundamental principle used here is that when the surveillance sensor has pitched, the direction of the gravity vector may not be straight down anymore from the perspective of the surveillance sensor. When the surveillance sensor has pitched, gravity may have a component along the longitudinal axis. The angle of the gravity vector in the longitudinal plane equals the surveillance sensor pitch angle.

The roll angle of the surveillance sensor can be measured by looking at the direction of the gravity vector. This is done when the vehicle is stationary to eliminate accelerations on the surveillance sensor other than gravity. Gravitational force is constantly pointing towards Earth. The fundamental principle used here is that when the surveillance sensor has rolled, the direction of the gravity vector may not be straight down anymore from the perspective of the surveillance sensor. When the surveillance sensor has rolled, gravity may have a component along the lateral axis. The angle of the gravity vector in the lateral plane equals the surveillance sensor's roll angle.

The yaw angle cannot be measured by looking at the direction of the gravity vector. If the surveillance sensor rotates around its vertical axis, the gravitational force still points straight down. Therefore, another method is required for detecting yaw. When the vehicle on which the surveillance sensor is mounted is accelerating (pulling up) or decelerating (braking, slowing down), acceleration or deceleration forces are put on the surveillance sensor. If the surveillance sensor has not rotated around its vertical axis with respect to the vehicle since its installation on the vehicle (i.e. yaw angle is equal to yaw angle at installation), these acceleration or deceleration forces are parallel to the longitudinal axis of the surveillance sensor. If the surveillance sensor has a yaw angle γ other than zero, the acceleration or deceleration vector may point partly in the surveillance sensor's lateral direction. The angle γ of the acceleration or deceleration force vector in the vertical plane equals the yaw of the surveillance sensor.

If a casing is not entirely watertight, it may not provide sufficient protection for a Printed Circuit Board (“PCB”) to which the surveillance sensor is connected. The printed circuit board may therefore not be sufficiently protected against outdoor elements. In such a case the printed circuit board can be dipped in a watertight resin, providing a protection layer for the printed circuit board. Alternatively, the manoeuvring assistant sensor and surveillance sensor may be placed in a watertight casing.

A preferred embodiment of the trailer according to the invention is characterized in that said manoeuvring guidance system comprises at least two manoeuvring assistant sensors mounted to said rear end portion of the trailer, each having a similar surveillance sensor operationally coupled therewith, wherein said control unit issues said warning signal in case the output signals of the surveillance sensors deviate more than said threshold from one another. Having two or more similar surveillance sensors, each monitoring their own manoeuvring assistant sensor, allows the control unit to compare their individual outputs. If they all change the same amount, no warning signal may be issued as this is more likely to be caused by a change in orientation of the trailer itself. If, on the other hand, one sensor outputs another signal than the other(s), this may be taken as damage to one of the sensors and the control unit may issue a corresponding warning to the user.

In a further preferred embodiment the trailer according to the invention is characterized in that said manoeuvring guidance system further comprises a reference sensor, similar to the at least one surveillance sensor, said reference sensor being mounted at a concealed, protected part of the trailer, wherein said control unit issues said warning signal in case an output signal of a surveillance sensor deviates more than said threshold from an output signal of said reference sensor. By being located in a concealed, protected area of the trailer, the reference sensor may be less likely to be damaged upon a moderate impact on the trailer than the manoeuvring assistant sensor(s) that are typically placed on an exposed and, hence, more vulnerable spot. The output signal of the reference sensor may, hence, be taken as a reliable reference value for comparison of the output signal(s) of the respective surveillance sensor(s) of the system. If a surveillance sensor output does not match, it may be indicative of damage to that sensor. The sensors are said to be similar, meaning they are of the same type and preferably of identical make.

To determine if the trailer is stationary, the acceleration detected by a three-dimensional accelerometer may be used. If the acceleration is below a certain threshold, the trailer can be considered stationary. In determining whether a trailer is accelerating or decelerating, a value of acceleration or deceleration detected by the surveillance sensor and a value of acceleration or deceleration detected by a reference sensor may be compared. An algorithm may be used to determine if the trailer is accelerating based on these compared values. The algorithm can also be used to indicate if the trailer is accelerating in a lateral direction or in a turning direction, i.e. making a corner. To determine if a trailer is on a sloped surface, the values of orientation of all surveillance sensors installed on the trailer are compared to the value of orientation of the reference sensor. If all the sensors, including the surveillance sensors, have the same angle, the vehicle is on a sloped surface. The reference sensor may also be connected to the brake lights of the vehicle to determine whether the trailer is decelerating (braking) or not with greater certainty.

A further specific embodiment of the trailer according to the invention is characterized in that the manoeuvring assistant sensor has a detection zone, the detection zone being adjustable, and the control unit having control means for adjusting the adjustable detection zone of the manoeuvring assistant sensor or for deactivating the manoeuvring assistant sensor when said deviation of the physical state of said manoeuvring assistant sensor is observed, exceeding said threshold. Changing the adjustable detection zone of the manoeuvring assistant sensor allows for the manoeuvring assistant sensor to still perform effectively after a change in the state of the manoeuvring assistant sensor. If the change of state is outside limits, the control means may also deactivate the manoeuvring assistant sensor. Switching the manoeuvring assistant sensor off prevents the manoeuvring assistant sensor from detecting objects in an undesired detection zone and consequently signalling false alarms to the user of the manoeuvring assistant sensor. Once the state of the manoeuvring assistant sensor has been readjusted to a predetermined state or the manoeuvring assistant sensor has been repaired or replaced, the surveillance sensor may detect this at the next checkpoint. The control means may then reactivate the manoeuvring assistant sensor.

In order to allow a user to trace all output signals delivered by the surveillance sensor, a further preferred embodiment of the trailer according to the invention is characterized in that said control unit comprises storage means for storing said output signal by said at least one surveillance sensor. The storage means may store the output values by the surveillance sensor in an electronic logbook. A history of all output signals delivered by the surveillance sensor may therefore be available to the user. The user can use this history to determine when an incident occurred that caused damage to the manoeuvring assistant sensor, or to the vehicle bumper on which the sensor is mounted.

In order to allow a third party to receive the warning signal submitted by the communication means, a further preferred embodiment of the trailer according to the invention is characterized in that the control unit is provided with communication means that connect to a remote server, to communicate said warning signal at least to said remote server. A third party, having access to the remote server, may be able to note any changes in the state of the manoeuvring assistant sensor via the remote server and, if necessary, may respond.

A further specific embodiment of the trailer according to the invention is characterized in that the manoeuvring assistant sensor is chosen from a group comprising: an infrared sensor, an ultrasonic sensor, an image sensor, particularly a camera, a laser and a radar, and particularly comprises an ultrasonic sensor. The alerting means may be located inside a cabin of said towing vehicle.

In a further aspect of the invention, a method of the type as described in the opening paragraph for guarding the condition of a manoeuvring assistant sensor of a manoeuvring guidance system mounted to a trailer is characterized by:
determining an initial value of at least one of a pitch, roll and yaw of said manoeuvring assistant sensor;
determining an actual value of said at least one of said pitch, roll and yaw of said manoeuvring assistant sensor;
comparing said actual value with the corresponding initial value; and
issuing a warning signal when a difference between said actual value and said initial value exceeds a predetermined threshold value.

In a particular embodiment, the method according to the invention is characterized in that said actual value is determined periodically to provide periodic values that are stored in an electronic memory. Said memory in that case provides a history of the detected states of the sensor that may be supplemented by a time stamp and location. Particularly that said initial value and said actual value may be determined by means of a surveillance sensor moving in conjunction with said manoeuvring assistant sensor.

According to said method, the surveillance sensor may be elected from a group, comprising an accelerometer, a magnetometer and a gyroscope, and in that a pitch and/or roll of the manoeuvring assistant sensor is determined by determining a pitch angle and/or roll angle respectively of said surveillance sensor with respect to gravity.

In a further particular embodiment, the method according to the invention is characterized in that a yaw angle of the manoeuvring assistant sensor is determined by determining a yaw angle of said surveillance sensor with regards to an acceleration vector or deceleration vector of said trailer.

In a further particular embodiment, the method according to the invention is characterized in that said manoeuvring guidance system comprises at least one further manoeuvring assistant sensor mounted to said exposed rear portion of said trailer, said further manoeuvring assistant sensor having a further surveillance sensor moving in conjunction therewith, in that said further surveillance sensor is similar to said first surveillance sensor, in that output signals of said first and further surveillance sensors are compared, and in that said warning signal is issued when said output signals deviate from one another more than a predetermined threshold value.

In a further particular embodiment, the method according to the invention is characterized in that a reference sensor is provided, the reference sensor being similar to said surveillance sensor and spatially separated from said surveillance sensor, and in that an output signal by said surveillance sensor is compared to an output signal by said reference sensor, and in that said warning signal is issued when said output signals deviate from one another more than a predetermined threshold value.

The invention may now be further elucidated on the basis of a number of exemplary embodiments and accompanying drawings. In the drawings:

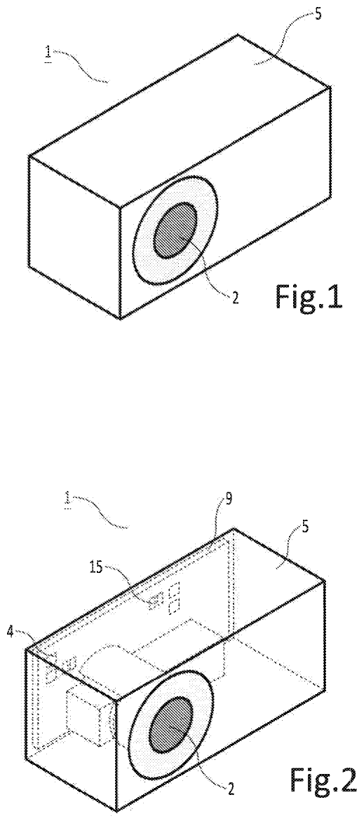

FIG. 1 shows a front left perspective view of a manoeuvring assistant sensor;

FIG. 2 shows a partially transparent front left perspective view of the manoeuvring assistant sensor of FIG. 1;

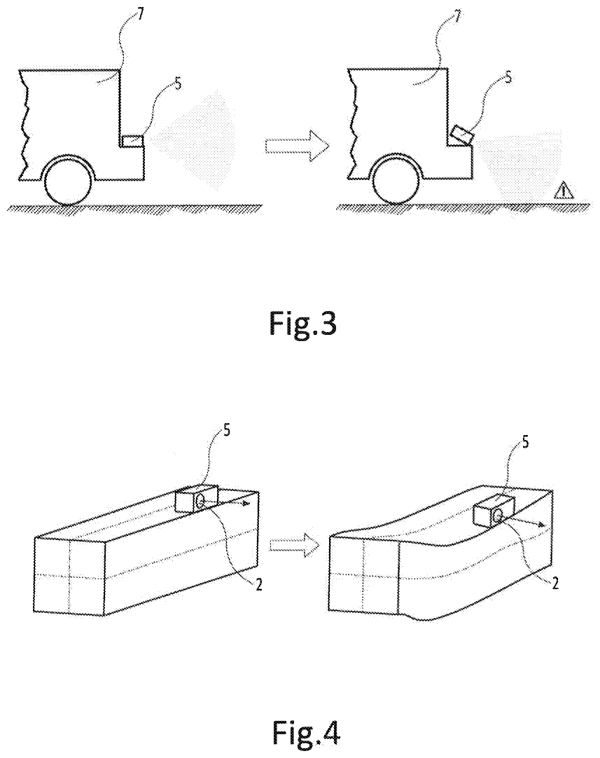

FIG. 3 shows a detailed view of a rear end of a truck with a manoeuvring assistant sensor installed on the vehicle where, in a first instance, the manoeuvring assistant sensor has a correct detection zone and, in a second instance, the manoeuvring assistant sensor has an incorrect detection zone;

FIG. 4 shows a detailed view of a manoeuvring assistant sensor installed on a vehicle where, in the first instance, the vehicle is undamaged and, in a second instance, the vehicle is damaged;

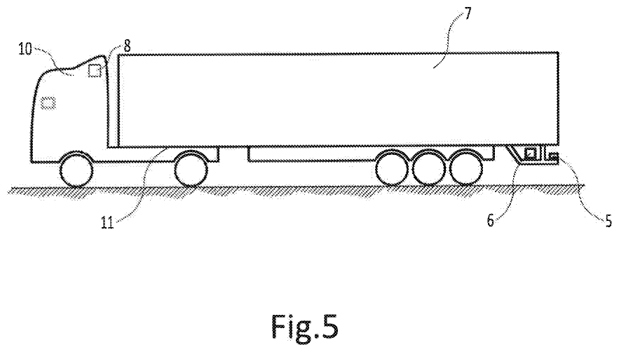

FIG. 5 shows a side view of a truck trailer with a manoeuvring guidance system installed thereto;

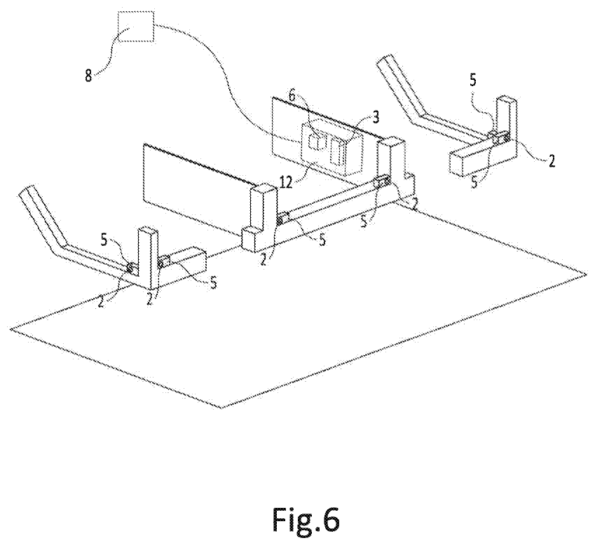

FIG. 6 shows a configuration of the manoeuvring guidance system installed to a vehicle;

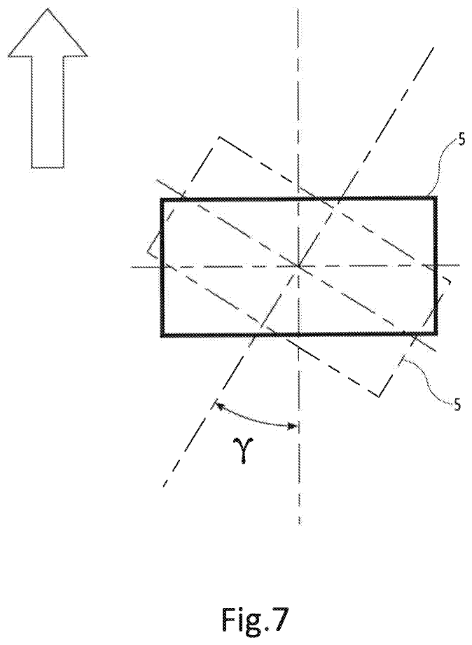

FIG. 7 shows a schematic representation of a top view of a manoeuvring assistant sensor in a first position having a correct yaw angle and in a second position having an incorrect yaw angle;

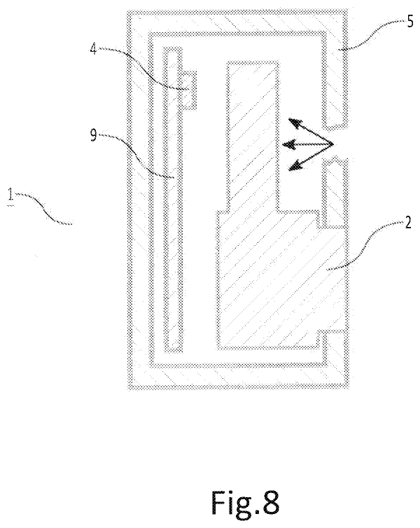

FIG. 8 shows a sectional top view of a closed casing with a manoeuvring assistant sensor, a printed circuit board and a surveillance sensor therein; and

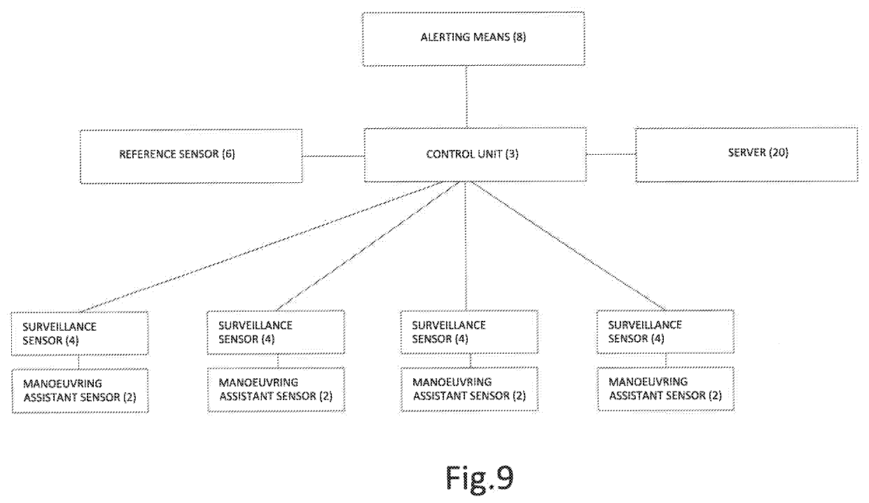

FIG. 9 shows a schematic diagram of the manoeuvring guidance system.

It is noted that the drawings are purely schematic and not drawn to scale. Some dimensions in particular may be exaggerated to greater or lesser extent for the sake of clarity. Corresponding parts are designated in the figures with the same reference numeral.

An exemplary embodiment of a trailer according to the invention is shown in FIGS. 1 to 9. A front end portion of the trailer comprises standard coupling means 11 for connecting to towing vehicle 10, in this case a truck. The trailer 7 is equipped with a manoeuvring guidance system 1 that includes one or more manoeuvring assistant sensor(s) 2, mounted at a rear end portion of the trailer 7, a control unit 3 hidden more concealed in the trailer frame, one or more surveillance sensor(s) 4 that are connected to the control unit 3 and alerting means 8. The control unit 3, moreover, is provided with communication means (not shown) that connect the control unit 3 over a power line of the trailer 7 and truck 10 to the alerting means 8 and further provide access to a remote server 20 over a public wireless network.

In this example, the manoeuvring assistant sensor 2 is an ultrasonic sensor or an infrared sensor which is located within a closed casing 5. The casing 5 is a rigid casing, in this case a rectangular casing, with an opening at a front thereof. A sensitive portion of the manoeuvring assistant sensor 2 extends through the opening. The manoeuvring assistant sensor 2 has an adjustable detection zone. The casing has securing means, for example, screw receiving formations and screws, for securing the casing 5 to a rear end portion and opposing sides of the trailer 7.

The surveillance sensor 4 may be a gyroscope, an accelerometer, a magnetometer, a pressure sensor or a light intensity sensor. In this embodiment, the surveillance sensor 4 comprises an accelerometer. The accelerometer 4 is attached to a printed circuit board 9 (“PCB”). The printed circuit board 9, with attached to it the accelerometer 4, is located within the casing 5 of the manoeuvring assistant sensor 2 at a rear side of the manoeuvring assistant sensor 2. The printed circuit board comprises a micro-controller chip assembly 15 that controls both the manoeuvring assistant sensor 2 as well as the accelerometer 4 and, moreover, communicates with the central control unit 3 further down the trailer. Alternatively, the manoeuvring assistant sensor 2 and the accelerometer 4 may communicate with the central control unit 3 directly without the need of a micro-controller for each sensor.

The accelerometer 4, residing in the same casing 5 as the manoeuvring assistant sensor 2, allows the accelerometer 4 to experience a similar change in its state as the manoeuvring assistant sensor 2. For example, should the manoeuvring assistant sensor 2 accelerate in an operatively forward direction at an acceleration, the adjacent printed circuit board 9 and therefore also the attached accelerometer 4 will accelerate at the same acceleration and in the same direction as the manoeuvring assistant sensor 2. The accelerometer 4 will therefore detect an acceleration that is indicative of the acceleration of the associated manoeuvring assistant sensor 2.

A reference sensor 6, of a type and make similar to the surveillance sensor 4 is concealed in a further casing, located at a remote, hidden portion of the trailer 7, that may also accommodate the control unit 3 in a common housing 12. In this example, the reference sensor, hence, also comprises an accelerometer like the one 4 that monitors the manoeuvring assistant sensor 2. Hidden inside the frame of the trailer 7, the reference sensor is optimally protected against any external impact. The reference accelerometer 6 has a state identical to the state of the first accelerometer 4 at installation thereof. The reference accelerometer 6 detects a value of acceleration as a reference value for comparison the value of acceleration of the first accelerometer 4.

Information regarding the acceleration experienced by the first accelerometer 4 is transmitted to the connected control unit 3 over suitable communication means. Likewise, the reference accelerometer 6 submits its output signal to the control unit 3 containing information of the acceleration experienced by the reference accelerometer 6. A difference in the values of acceleration experienced by the first accelerometer 4 and the reference accelerometer 6 will be indicative of a change in the state of the first accelerometer 4.

The control unit 3 interprets the output signals received from the first and second accelerometers and submits a warning signal representative of a damage to the sensor 4 to be received to alerting means 8 that are for instance installed inside the cabin of a towing vehicle. The control unit 3 is particularly able to communicate over an electric power cable of the vehicle to exchange said warning using a customary or proprietary data communication protocol. The alerting means may provide a light, an alarm, a display unit, a communication means or the like. In this case, the alerting means is a display unit located in a cabin of the trailer 7. The display unit may receive a warning signal in the form of a pop-up message on the display unit from the communication means, indicating the change in the state of the manoeuvring assistant sensor 2.

A remote server is connected to the control unit 3 by further communication means to allow the control unit 3 submitting a similar warning signal to a remote server when a change in the state of the manoeuvring assistant sensor 2 occurs. Further, the control unit 3 may include control means for controlling the adjustable detection zone of the manoeuvring assistant sensor 2. Should the value of the change in the state of the manoeuvring assistant sensor 2 be outside a predetermine threshold, the control means may attempt to adjust the detection zone of the manoeuvring assistant sensor 2 to a predetermined state. The control means may also deactivate the manoeuvring assistant sensor 2 when the value of the change in the state thereof is outside a predetermine threshold. By adjusting the detection zone of the manoeuvring assistant sensor 2 or deactivating the manoeuvring assistant sensor 2, the manoeuvring assistant sensor 2 is prevented from detecting objects outside a desired detection zone. Once the state of the manoeuvring assistant sensor 2 is readjusted to a predetermined state, the control unit 3 may reactivate the manoeuvring assistant sensor 2.

The control unit 3 also includes storage means for storing all output signals delivered by the first accelerometer 4 to the communication means. The output signals are stored in a logbook. A history report of said transmitted output signals can be retrieved indicating information regarding all output signals transmitted by the first accelerometer 4, including the time and date that the output signal was transmitted and the value of the change in state of the manoeuvring assistant sensor 2.

In a preferred configuration of the manoeuvring guidance system, shown in FIG. 6, comprises four spaced apart casings 5 that are secured to a rear end of the frame 7, each containing a manoeuvring assistant sensor 2 together with a printed circuit board 9 and a surveillance sensor 4, comprising an accelerometer. The manoeuvring guidance system further comprises a reference accelerometer 6 that is housed in a further casing together with a control unit 3 that is connected to the printed circuit boards 9 of the individual sensors 2,4. The control unit 3 and reference sensor 6 are secured at a central, concealed part of the frame to be protected against external impacts to the trailer 7.

Two casings 5 with the associated part of the guidance system are secured to two opposing sides of the frame of the trailer 7 and towards rear ends of said frame. The manoeuvring assistant sensors 2 at the rear side of the trailer 7 may detect objects within predetermined detection zones at the rear end of the trailer 7 and the manoeuvring assistant sensors 2 at the opposing sides of the trailer 7 may detect objects within predetermined detection zones on the opposing sides of the trailer 7.

The output signals of the individual surveillance sensors 4 may be compared with one another and provide mutual reference signals that may be interpreted by the control unit 3 to detect an anomaly among the sensors 4. That anomaly may be indicative of the damaged manoeuvring assistant sensor 2 that is thereby being monitored. If all sensors 4 indicate an anomaly, their output signals may still be compared with that of the reference sensor 6. If the outputs match, this will be considered to be caused by a modified orientation of the trailer as a whole, without a warning signal being issued by the control unit 3.

Although the invention has been further elucidated and described above with reference to only several exemplary embodiments, it may be apparent that the invention is by no means limited thereto. On the contrary, many variations and embodiments are still possible within the scope of the invention for the person with ordinary skill in the art.

1. A trailer comprising a front end portion with coupling means for coupling a towing vehicle, particularly a truck, a rear end portion, and a manoeuvring guidance system, comprising a control unit and at least one manoeuvring assistant sensor mounted to said rear end portion of said trailer, wherein each of said at least one manoeuvring assistant sensor is operationally coupled to at least one surveillance sensor that senses a change in a physical state of the manoeuvring assistant sensor associated therewith to deliver a corresponding output signal to said control unit over communication means that mutually connect said surveillance sensor and said control unit, and wherein said control unit issues a warning signal to alerting means in case a deviation of said physical state is observed that exceeds a threshold.

2. A trailer according to claim 1, wherein said manoeuvring assistant sensor and surveillance sensor are located within a common casing.

3. A trailer according to claim 2, wherein said common casing is a closed casing.

4. A trailer according to claim 3, wherein said surveillance sensor is a light intensity sensor or a pressure sensor inside said housing.

5. A trailer according to claim 1, wherein said surveillance sensor is an accelerometer, a magnetometer or a gyroscope that moves in conjunction with the manoeuvring assistant sensor.

6. A trailer according to claim 1, wherein said manoeuvring guidance system comprises at least two manoeuvring assistant sensors mounted to said rear end portion of the trailer, each having a similar surveillance sensor operationally coupled therewith, wherein said control unit issues said warning signal in case the output signals of the surveillance sensors deviate more than said threshold from one another.

7. A trailer according to claim 1, wherein said manoeuvring guidance system further comprises a reference sensor, similar to the at least one surveillance sensor, said reference sensor being mounted at a concealed, protected part of the trailer, wherein said control unit issues said warning signal in case an output signal of a surveillance sensor deviates more than said threshold from an output signal of said reference sensor.

8. A trailer according to claim 1, wherein the manoeuvring assistant sensor has a detection zone, the detection zone being adjustable, and the control unit having control means for adjusting the adjustable detection zone of the manoeuvring assistant sensor or for deactivating the manoeuvring assistant sensor when said deviation of the physical state of said manoeuvring assistant sensor is observed, exceeding said threshold.

9. A trailer according to claim 1, wherein said control unit includes storage means for storing said output signal by said at least one surveillance sensor.

10. A trailer according to claim 1, wherein the control unit is provided with communication means that connect to a remote server, to communicate said warning signal at least to said remote server.

11. A trailer according to claim 1, wherein the manoeuvring assistant sensor is chosen from a group comprising: an infrared sensor, an ultrasonic sensor, an image sensor, particularly a camera, a laser and a radar, and particularly comprises an ultrasonic sensor.

12. A trailer according to claim 1, wherein the alerting means are located inside a cabin of said towing vehicle.

13. A method for guarding a condition of at least one manoeuvring assistant sensor of a manoeuvring guidance system comprising at least one manoeuvring assistant sensor mounted to an exposed rear portion of a trailer, said method comprising:
determining an initial value of at least one of a pitch, roll and yaw of said manoeuvring assistant sensor;
determining an actual value of said at least one of said pitch, roll and yaw of said manoeuvring assistant sensor;
comparing said actual value with the corresponding initial value; and
issuing a warning signal when a difference between said actual value and said initial value exceeds a predetermined threshold value.

14. A method according to claim 13, wherein said actual value is determined periodically to provide periodic values that are stored in an electronic memory.

15. A method according to claims 13 to 14, wherein said initial value and said actual value are determined by means of a surveillance sensor moving in conjunction with said manoeuvring assistant sensor.

16. A method according to claim 15, wherein said surveillance sensor is elected from a group, comprising an accelerometer, a magnetometer and a gyroscope, and in that and wherein a pitch and/or roll of the manoeuvring assistant sensor is determined by determining a pitch angle and/or roll angle respectively of said surveillance sensor with respect to gravity.

17. A method according to claim 15, wherein a yaw angle of the manoeuvring assistant sensor is determined by determining a yaw angle of said surveillance sensor with regards to an acceleration vector or deceleration vector of said trailer.

18. A method according to claim 15, wherein said manoeuvring guidance system comprises at least one further manoeuvring assistant sensor mounted to said exposed rear portion of said trailer, said further manoeuvring assistant sensor having a further surveillance sensor moving in conjunction therewith, wherein said further surveillance sensor is similar to said first surveillance sensor, wherein output signals of said first and further surveillance sensors are compared, and wherein said warning signal is issued when said output signals deviate from one another more than a predetermined threshold value.

19. A method according to claim 15, wherein a reference sensor is provided, the reference sensor being similar to said surveillance sensor and spatially separated from said surveillance sensor, and wherein an output signal by said surveillance sensor is compared to an output signal by said reference sensor, and wherein said warning signal is issued when said output signals deviate from one another more than a predetermined threshold value.
